(19) United States
(12) Patent Application Publication
(10) Pub. No.: US 2016/0318171 A1
(43) Pub. Date: Nov. 3, 2016

(54) TELESCOPIC SAW

(71) Applicant: Joseph Gonzales, Spring, TX (US)

(72) Inventor: Joseph Gonzales, Spring, TX (US)

(21) Appl. No.: 15/092,552

(22) Filed: Apr. 6, 2016

Related U.S. Application Data
(60) Provisional application No. 62/155,375, filed on Apr. 30, 2015.

(51) Int. Cl. B25G 1/04; B23D 49/16; A01G 3/08

(52) U.S. Cl. CPC B25G 1/04; A01G 3/085; B23D 49/16

(57) ABSTRACT

A telescopic saw includes a handle, a power switch, one or more telescopic poles, an electric reciprocating saw holder and a saw blade. The handle houses a battery within a holder section of the handle, and the power switch is positioned at a distal end of the handle, and in communication with the battery. The telescopic poles are attached to each other and extending from the handle, where a last of the telescopic poles is pivotally connected to the second last telescopic pole. The electric reciprocating saw holder is fastened to a distal end of the last telescopic pole, where the electric reciprocating saw holder holds the saw blade. The saw blade is hingedly connected to the electric reciprocating saw holder, where the saw blade sways along a predefined angle in horizontal direction, and reciprocate linearly to prune an object, when the power switch is actuated by a user.

### CROSS REFERENCE TO RELATED APPLICATIONS

This application claims the benefit of provisional patent application No. 62/155,375, filed in the United States Patent and Trademark Office on Apr. 30, 2015. The specification of the above referenced patent application is incorporated herein by reference in its entirety.

### BACKGROUND

There are different types of sawing mechanisms widely used around the world. The most commonly used one is the conventional chainsaw, which includes a saw blade built into a chain. Generally, the chain is bound around an elongated metal guide bar, and driven by a small, single cylinder gasoline engine. The chain runs around sprockets, such as gear wheels, considered to turn continuously with teeth made from a hardened steel alloy mounted along its intervals. Within the engine, as the piston reciprocates back and forth inside the cylinder, and it pushes a connecting rod which turns a crankshaft. The crankshaft turns gears that are coupled through a centrifugal clutch, to one of the sprockets on which the chain is mounted, and therefore the chain spins around. The design of such conventional chainsaws is complicated and requires consistent maintenance to keep the chainsaws in working condition.

Therefore, there is a requirement for a method or a device, which can eliminate the issue of heavy gas, powered tools, as well as heavy chainsaw heads, which require regular maintenance. Regular maintenance that needs to be avoided includes refueling, lube for chain; cleanup of chainsaw and troubles of engine startup. In case, if we need to use the chainsaw at a height, additional height increasing means are required to be added to the basic design of the chainsaw which is a cumbersome process. Some battery powered sawing tools have no means of height increasing and use heavy chainsaw head, which requires same maintenance as gas powered tool.

Hence, there is a long felt but unresolved need for a telescopic saw, which can resolve the issues that were mentioned above.

### SUMMARY OF THE INVENTION

The telescopic addresses and resolves the issues mentioned in the background. The telescopic saw comprises a handle, a power switch, one or more telescopic poles, an electric reciprocating saw holder, and a saw blade. The handle houses a battery within a battery holder section of the handle, and the power switch is positioned at a distal end of the handle, and in communication with the battery. The telescopic poles are attached to each other and extending from the handle, where a last of the telescopic poles is pivotally connected to the second last telescopic pole. The electric reciprocating saw holder is fastened to a distal end of the last telescopic pole, where the electric reciprocating saw holder holds the saw blade. The saw blade is hingedly connected to the electric reciprocating saw holder, where the saw blade is configured to sway along a predefined angle in the horizontal direction, and reciprocate linearly to prune an object, when the power switch is actuated by a user.

In an embodiment, the battery is a rechargeable battery, for example, a lithium ion or a nickel cadmium type. In an embodiment, a set of electric leads from the power switch are connected to a spring loaded wire spool to actuate the spring loaded wire spool. In an embodiment, the telescopic saw further comprises a spool housing configured to house the spring loaded wire spool. In an embodiment, the telescopic saw further comprises a telescopic lock configured to lock a required length between the telescopic poles when inserted into each other. In an embodiment, the telescopic saw further comprises an adjustable locking hinge connected between the last telescopic pole and the second last telescopic pole to provide a hinged movement of the last telescopic pole.

In an embodiment, a wire member driven by the spring-loaded wire spool is drawn through the telescopic poles to be in communication with the electric reciprocating saw motor via the adjustable locking hinge, which allows for setting the electric reciprocating saw holder in the predefined angle and to generate the pruning action of the saw blade. In an embodiment, the telescopic saw further comprises one or more fasteners configured to fasten the electric reciprocating saw holder to the last telescopic pole. In an embodiment, the telescopic saw further comprises a quick release member positioned between the saw blade and the electric reciprocating saw holder, where the quick release member is configured to enable quick release and connection of the saw blade to the electric reciprocating saw holder.

### BRIEF DESCRIPTION OF THE DRAWINGS

FIG. 1 exemplarily illustrates a front perspective view of an embodiment of the telescopic saw.

FIG. 2 exemplarily illustrates a front perspective view of another embodiment of the telescopic saw.

FIG. 3 exemplarily illustrates an internal front perspective view proximal to the handle of the telescopic saw.

FIG. 4 exemplarily illustrates a front perspective view of the telescopic lock of the telescopic saw.

FIG. 5-6 exemplarily illustrates a top perspective view and a side perspective view of the adjustable locking hinge of the telescopic saw.

FIG. 7 exemplarily illustrates a front perspective view proximal to the saw blade of the telescopic saw.

### DETAILED DESCRIPTION OF THE INVENTION

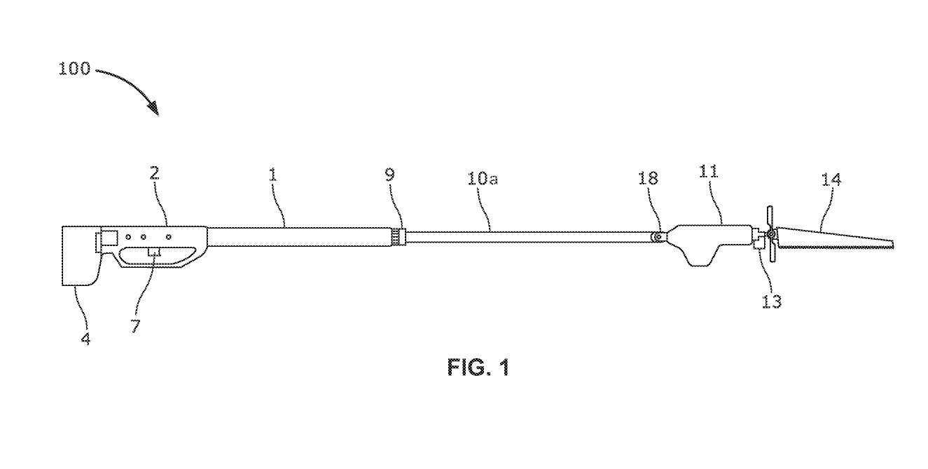

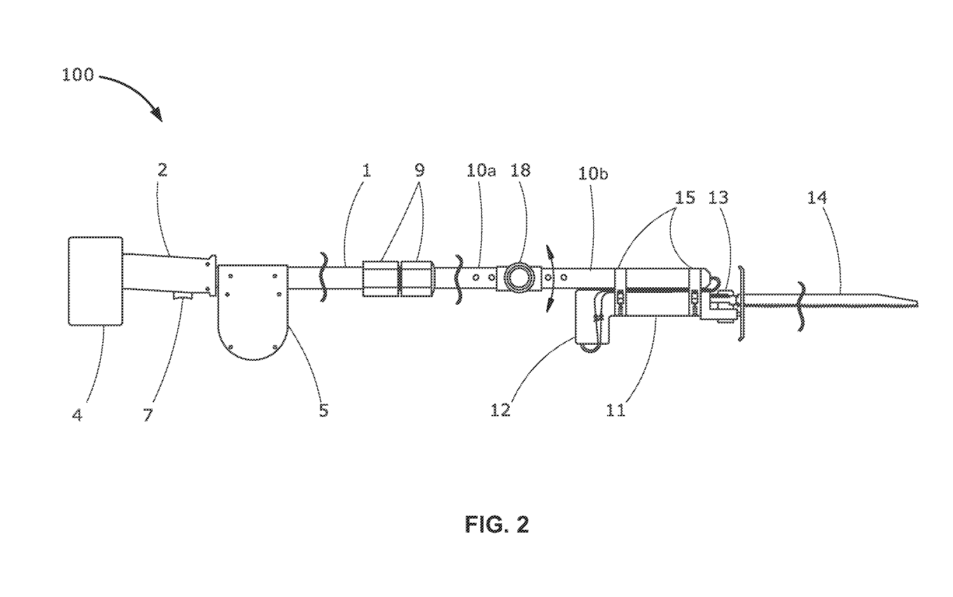

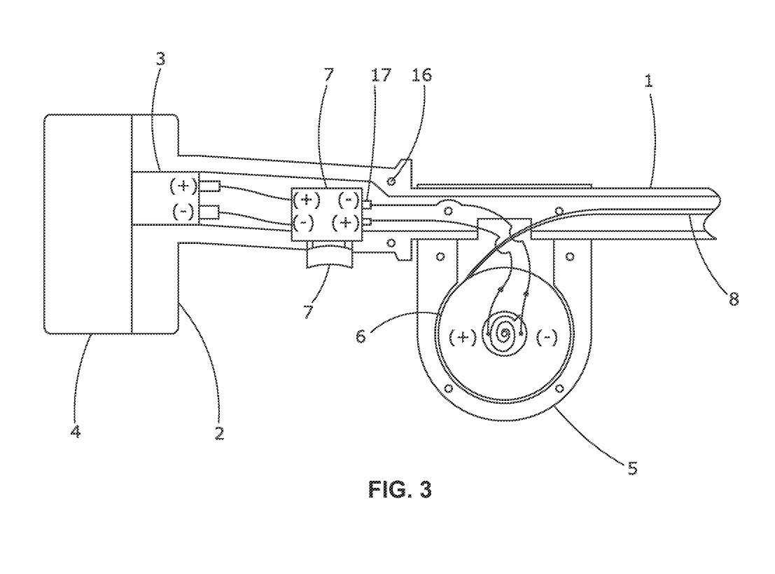

FIG. 1 exemplarily illustrates a front perspective view of an embodiment of the telescopic saw 100, and FIG. 2 exemplarily illustrates a front perspective view of another embodiment of the telescopic saw 100. The telescopic saw 100 comprises a handle 2, a power switch 7, one or more telescopic poles 1, 10a and 10b, an electric reciprocating saw holder 11, and a saw blade 14. The handle 2 houses a battery 3 within a battery holder section 4 of the handle 2 as shown in FIG. 3, and the power switch 7 is positioned distally to the handle 2, and in communication with the battery 3. The telescopic poles 1, 10a and 10b are attached to each other and extending from the handle 2, where a last of the telescopic poles 10b is pivotally connected to the second last telescopic pole 10a. The electric reciprocating saw holder 11 is fastened to a distal end of the last telescopic pole 10b, where the electric reciprocating saw holder 11 holds the saw blade 14. The saw blade 14 is hingedly connected to the electric reciprocating saw holder 11, where the saw blade 14 is configured to sway along a predefined angle in the horizontal direction, and reciprocate linearly to prune an object, when the power switch is actuated by a user.

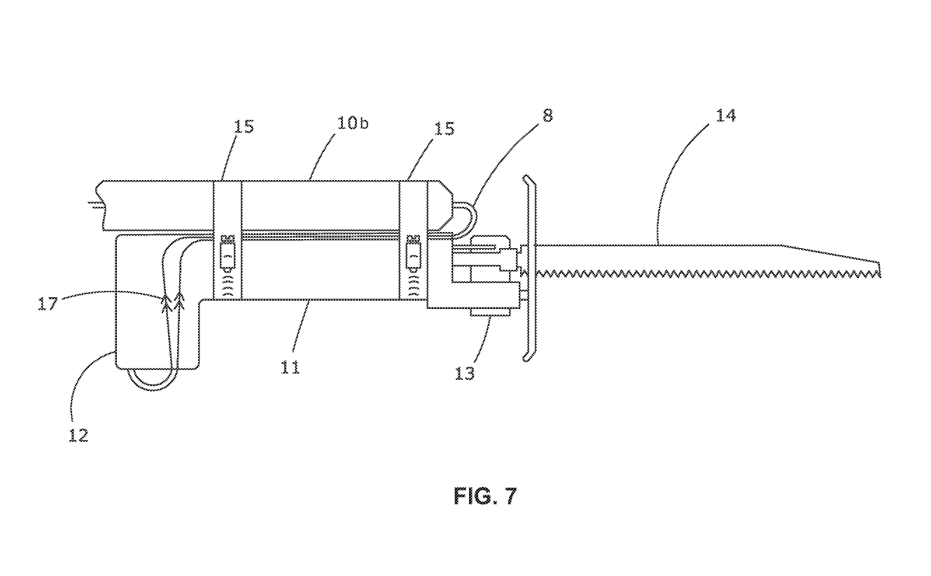

FIG. 3 exemplarily illustrates an internal front perspective view proximal to the handle 2 of the telescopic saw 100. In an embodiment, the battery 3 is a rechargeable battery, for example, a lithium ion or a nickel cadmium type, and in another embodiment, a set of electric leads 17 from the power switch 7 are connected to a spring loaded wire spool 6 to actuate the spring loaded wire spool 6, which will further actuate a reciprocating saw motor 12 positioned inside the electric reciprocating saw holder 11. As shown here, as a user presses the power switch 7 in communication with the battery 3 via leads, the power switch 7 actuates the reciprocating saw motor 12 to cause reciprocating motion of electric reciprocating saw holder 11 and saw blade 14 as shown in FIGS. 1-2, and therefore actuates the electric reciprocating saw motor 12. In an embodiment, the telescopic saw 100 further comprises a spool housing 5 configured to house the spring loaded wire spool 6, for example, a spring loaded wire spool 6 which retrieves wire when pole is retracted using spring tension with reference to electric reciprocating saw holder 11 as shown in FIGS. 2 and 7.

The electric reciprocating saw motor 12 is mountable onto the electric reciprocating saw holder 11. In an embodiment, a wire member 8 driven by the spring loaded wire spool 6 is drawn through the telescopic poles 1, 10a and 10b to be in communication with the electric reciprocating saw motor 12 via an adjustable locking hinge 18 which allows for manually setting the electric reciprocating saw holder 11 in the predefined angle and to generate the pruning action of the saw blade 14, that is, the wire member 8 from spool housing 5 is hard wired from the spring loaded wire spool 6 to wire member 8.

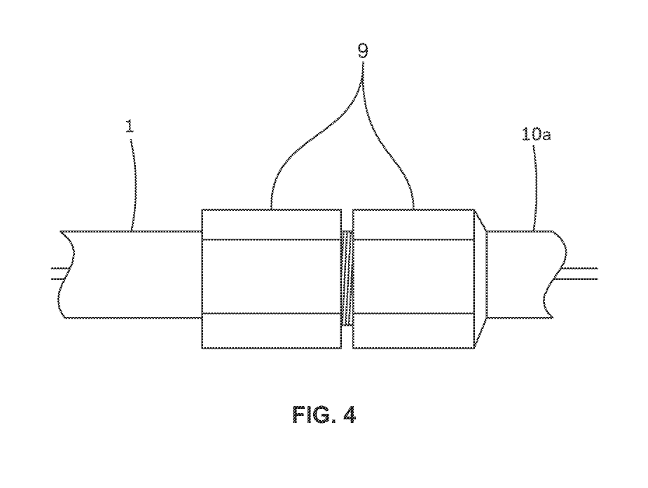

FIG. 4 exemplarily illustrates a front perspective view of the telescopic lock 9 of the telescopic saw 100. In an embodiment, the telescopic saw 100 further comprises the telescopic lock 9 configured to lock a required length between one or more of the telescopic poles 1, 10a and 10b when inserted into each other. There are different types of telescopic locks 9, for example, cam lock type, locking cone type, pin lock type etc. In the cam lock type, the cam is located inside and by twisting the telescopic poles 1, 10a and 10b the cam is pressed or locked inside against a second telescopic pole 10a with respect to a first telescopic pole 1. Here, it can be a tapered cam or an off centered cam. The second telescopic pole 10a has one style of the lever lock where it pinches one pole's 1 outside tightly against the other poles 10a inside locking them in place. The last is the pin lock where a pin falls into a predrilled hole to keep the pole in place. In the case of the locking cone type, a tapered cone is tightened down against the fingers locking the telescopic poles 1, 10a and 10b in place. Twist locks come in several sizes to work with the different diameters of the poles or tubing. In the case of pin locks, a button is pushed to lift, or depress the pin, which a user can slide out of any of the poles to the desired length. Pin lock style lets the user to lock the pole into the desired length.

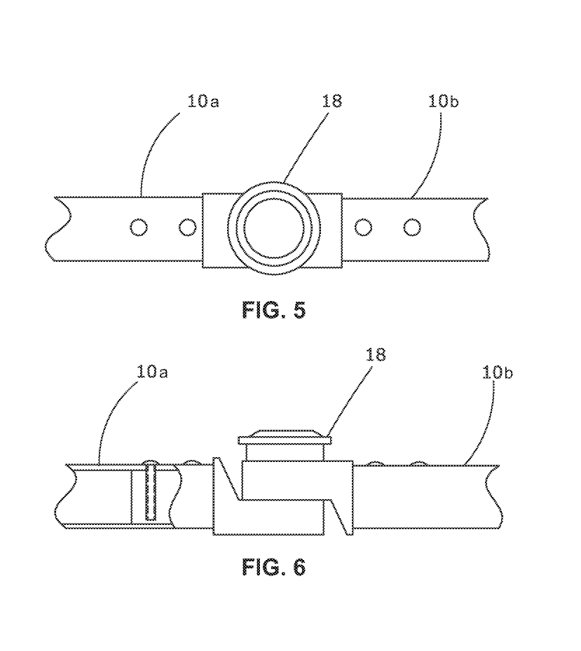

FIG. 5-6 exemplarily illustrates a top perspective view and a side perspective view of the adjustable locking hinge 18 of the telescopic saw 100. In an embodiment, the telescopic saw further comprises an adjustable locking hinge 18 connected between the last telescopic pole 10b and the second last telescopic pole 10a to provide a hinged movement of the last telescopic pole 10b. The hinged movement of the last telescopic pole 10b allows the user to turn the angle of the saw blade 14 so that the pruning action using the saw blade 14 can be performed at a desired angle at elevated heights.

FIG. 7 exemplarily illustrates a front perspective view proximal to the saw blade 14 of the telescopic saw 100. In an embodiment, the telescopic saw 100 further comprises one or more fasteners 15 configured to fasten the electric reciprocating saw holder 11 and the reciprocating saw motor 12 to the last telescopic pole 10b. In an embodiment, the telescopic saw 100 further comprises a quick release member 13 positioned between the saw blade 14 and the electric reciprocating saw holder 11, where the quick release member 13 is configured to enable quick release and connection of the saw blade 14 to the electric reciprocating saw holder 11.

Saw blades 14 of up to, for example, 12 inches can be used on a reciprocating tool head positioned within the electric reciprocating saw holder 11. The telescopic saw can be used to cut thin wall metal, pipe, sheet rock, wood, for example, 2×4s by dimension, by simply changing the blade for applicable material. The saw blades 14 are readily available at most hardware stores, and the blade replacement time is approximately, for example, 20 seconds or less as opposed to chain replacement of other conventional tools. The saw blades 14 compared to chains are cost effective. Since the telescopic saw 100 is battery 3 powered, it eliminates extension cords, and is lightweight, easy for operation, with low maintenance, and cost-effective. Although the telescopic saw 100 has been explained in relation to its preferred embodiments, it is to be understood that many other possible modifications and variations can be made without departing from the spirit and scope of the invention.

The foregoing examples have been provided merely for the purpose of explanation and are in no way to be construed as limiting of the present concept disclosed herein. While the concept has been described with reference to various embodiments, it is understood that the words, which have been used herein, are words of description and illustration, rather than words of limitation. Further, although the concept has been described herein with reference to particular means, materials, and embodiments, the concept is not intended to be limited to the particulars disclosed herein; rather, the concept extends to all functionally equivalent structures, methods and uses, such as are within the scope of the appended claims. Those skilled in the art, having the benefit of the teachings of this specification, may affect numerous modifications thereto and changes may be made without departing from the scope and spirit of the concept in its aspects.

1. A telescopic saw comprising:
a handle housing a battery within a battery holder section of the handle;
a power switch positioned at a distal end of the handle, and in communication with the battery;
one or more telescopic poles attached to each other and extending from the handle, wherein a last of the telescopic poles is pivotally connected to the second last telescopic pole;
an electric reciprocating saw holder fastened to a distal end of the last telescopic pole, wherein the electric reciprocating saw holder holds a saw blade; and
the saw blade hingedly connected to the electric reciprocating saw holder, wherein the saw blade is configured to sway along a predefined angle in the horizontal direction, and reciprocate linearly to prune an object, when the power switch is actuated by a user.

2. The telescopic saw of claim 1, wherein the battery is a rechargeable battery of one of lithium ion and nickel cadmium type.

3. The telescopic saw of claim 1, wherein a set of electric leads from the power switch are connected to a spring loaded wire spool to actuate the spring loaded wire spool, which further actuates a reciprocating saw motor positioned inside the electric reciprocating saw holder.

4. The telescopic saw of claim 3, further comprising a spool housing configured to house the spring loaded wire spool.

5. The telescopic saw of claim 1, further comprising an adjustable locking hinge connected between the last telescopic pole and the second last telescopic pole to provide a hinged movement of the last telescopic pole.

6. The telescopic saw of claim 5, wherein a wire member driven by the spring loaded wire spool is drawn through the telescopic poles to be in communication with the electric reciprocating saw motor via the adjustable locking hinge which allows for setting the electric reciprocating saw mechanism in the predefined angle, and to generate the pruning action of the saw blade.

7. The telescopic saw of claim 1, further comprising one or more fasteners configured to fasten the electric reciprocating saw holder to the last telescopic pole.

8. The telescopic saw of claim 1, further comprising a telescopic lock configured to lock a required length between one or more of the telescopic poles when inserted into each other.

9. The telescopic saw of claim 1, further comprising a quick release member positioned between the saw blade and the electric reciprocating saw holder, wherein the quick release member is configured to enable quick release and connection of the saw blade to the electric reciprocating saw holder.
